(19) United States
(12) Patent Application Publication
(10) Pub. No.: US 2009/0302986 A1
(43) Pub. Date: Dec. 10, 2009

(54) Minimal-length windings for reduction of copper power losses in magnetic elements

(76) Inventor: Tiberiu A. Bedea, Montreal (CA)

Correspondence Address: Tiberiu Bedea, 3360 Chemin Cote-Ste-Catherine Cote-Des-Neige, #4, Montreal, QC, H3T 1C6, CA

(21) Appl. No.: 12/155,781

(22) Filed: Jun. 10, 2008

(51) Int. Cl. H01F 27/28; H01F 27/08

(52) U.S. Cl. 336/55; 336/225

(57) ABSTRACT

The present invention discloses means for reducing copper power losses in windings of magnetic elements by minimizing their length. This is achieved by winding a continuous copper foil of a specific geometrical design at least one turn over a ferromagnetic core with the surface of the foil parallel to the surface of the core The transformer may have high or low turn ratios, may also use winding coil formers to achieve proper creepage and clearance and may use a compressible, thermally conductive pad for facilitating heat dissipation.

### FIELD OF THE INVENTION

The present invention relates to the magnetic elements (e.g. transformers and inductors) used in switching power supplies, including windings, power transformers, output filter and other associated components. The invention proposes winding geometries that reduce copper power losses by about 50%.

### BACKGROUND OF THE INVENTION

The magnetic elements (hereinafter called magnetics) used in switching power supplies experience power losses in the core and in the transformer windings. These losses generate internal heat that limits the operating temperature of the elements. The reduction of these losses is a crucial product design goal and a determinant factor of the product reliability.

One solution for magnetics, especially for high power application is implemented in Planetics products, made by the Payton Group. Other implementations are described by Estrov et al in U.S. Pat. No. 5,010,314. Such prior art presents windings made of copper foils (e.g. lead frames) or flat copper spirals (e.g. printed circuit board—PCB), laminated in thin dielectric epoxy with thin Kapton® insulators separating multiple layers. However, due to their geometric dimensions, the corresponding direct current (DC) and alternating current (AC) power losses per winding turn in such prior art windings are approximately twice as large as those achieved by the present invention. Both DC and AC power losses contribute to what in the technical jargon is known as copper losses. These are ohmic power losses manifested in the secondary winding of the magnetics. For example, but not limited to, transformers built according to the teachings of the present invention provide increased efficiency in systems used in outdoors applications (e.g. avionics, automotive, etc) where a major concern is represented by the heat dissipated in transformers. Additionally, reduced power losses result in increased magnetic component reliability, as the resulting reduction of heat yielded by the magnetic contributes to preserve the integrity of the electric insulation material. For automotive applications, where typical high-power inverters use turn ratios of 4 or less (e.g. 12 V stepped-up to 36 V), embodiments presented herein offer a solution that is more energy efficient than those found in the prior art. Said energy efficiency is supplemented by lower operational temperatures, lower cost and simplified manufacture.

The same theoretical, technical, manufacture and cost considerations used to optimize planar transformer technologies can be applied to the invention herein. For example, copper foils or multilayer PCB can be used as a substitute for magnetic wires in order to reduce winding power losses, by minimizing the detrimental effects of Eddy currents, skin and proximity effects. Note that in the context of the present invention, the term “copper foil” is used to designate any flat, conductive material used for constructing magnetics windings. Therefore “copper foil” may include multilayer flexible PCB used in constructing such windings. Wires featuring a flat-shaped cross-section are typically used instead of other cross-sectional shapes because of electrical conductivity advantages well known in the art, such as minimizing negative consequences of the skin effect. Furthermore, in order to handle high currents, the copper foil of the winding has to be thick or the number of layers of said copper foil has to be increased. In order to reduce AC power losses, the thickness of the copper foil is selected considering the desired operating frequency, accounting for the skin effect and Eddy currents. When the winding comprises multiple layers, each winding layer is electrically insulated from neighboring layers, using appropriate and currently available materials such as Kapton® or printed circuit board (PCB), so as to eliminate any possible inter-winding short-circuiting contacts. As an added benefit, proper winding insulation will reduce or eliminate Eddy currents.

Electrical transformers transfer energy with finite efficiency. A higher efficiency results in less heat generation in the magnetics or transformer and lower temperature rise. It is well known that the heat dissipated in the transformer has two components: a) the core heat—which depends on the core volume, core material, operating frequency and magnetic induction; and b) power loss in the transformer windings, known as copper losses. The volume of the transformer core defines the maximum transmitted power. The cross-sectional area of the winding wire or foil is determined by the current that needs to be transmitted. Therefore, in order to minimize copper losses, one can only optimize the winding geometry, its cross-section being determined by the current density. One geometrical aspect that can immediately impact power losses is the length of the winding. By reducing the winding length, the electrical resistance is reduced proportionally. The ohmic power losses, or copper losses, are directly dependent on the winding resistance. Consequently, a reduced winding length results in reduced power losses in the winding. In applications where, at a given output power, high output currents are required, the use of magnetic wire is not an optimal manufacturing solution. Prior art planar transformer technologies optimize AC power losses by minimizing the consequences of the skin effect and the amount of Eddy currents. For additional details, the reader is referred to “Eddy current losses in transformer windings and circuit wiring” by L. H. Dixon, Texas Instruments. The reduction of AC power losses, for a given magnetic core, is presently achieved by using cooper foils or PCB in the winding design and manufacturing. The prior art does not present effective solutions to minimize copper losses. The technology proposed by the invention herein addresses optimal winding turn geometries which minimize copper power losses.

Not departing from the theoretical principles and background used in the development of planar transformers, (see U.S. Pat. Nos. 5,010,314, 6,211,767), the invention proposed herein minimizes copper losses by reducing the length of each turn of the winding. Given that the maximum power transferred from the primary to the secondary of a transformer is proportional to its core volume, the proposed invention reduces copper losses by reducing the length of the secondary windings. Implicitly, the copper consumption and the costs are reduced accordingly. The concept of minimizing a winding turn length relies on the known mathematical fact that among all geometrical two-dimensional (2-D) figures of a specific area a circle has the lowest circumference or perimeter. As a result, for typical cores, such as those described above, the winding turn length can be reduced by 50%. Consequently, the proposed invention has significant efficiency and cost benefits over technologies presented or used in prior art.

### SUMMARY OF THE INVENTION

The present invention provides methods, windings and transformers to reduce copper losses by minimizing the length of windings.

In a preferred embodiment, a method is provided to reduce copper losses in magnetics. This is achieved by minimizing the length of a winding turn by winding a continuous copper foil of a specific geometrical design at least one turn over a ferromagnetic core with the surface of the foil parallel to the surface of the core so as to achieve a winding turn-length quasi-equal to the length of the core cross-section perimeter, thus effectively surrounding the entire cross-sectional area of the ferromagnetic core with the shortest possible winding length.

In another embodiment, a winding is provided that comprises at least one winding turn that, for a given magnetics core volume, has a minimized length obtained by winding a continuous copper foil of a specific geometrical design at least one turn over a ferromagnetic core with the surface of the foil parallel to the surface of the core so as to achieve a winding turn-length quasi-equal to the length of the core cross-section perimeter, thus effectively surrounding the entire cross-sectional area of the ferromagnetic core with the shortest possible winding length.

In yet another embodiment, a transformer is provided that comprises a secondary winding with at least one winding turn that has reduced copper losses by minimizing the said at least one winding turn length by winding a continuous copper foil of a specific geometrical design at least one turn over a ferromagnetic core with the surface of the foil parallel to the surface of the core so as to achieve a winding turn-length quasi-equal to the length of the core cross-section perimeter, thus effectively surrounding the entire cross-sectional area of the ferromagnetic core with the shortest possible winding length.

Said transformer may have high or low turn ratios. Said transformer may also use winding coil formers in order to ensure proper creepage and clearance, according to the applicable safety standards. Said transformer may also use a core that is placed in contact with a thermally conductive U-shaped top and a thermally conductive base plate via a compressible conductive pad, said pad featuring holes for facilitating its attachment to an external heat-sink.

### BRIEF DESCRIPTION OF THE DRAWINGS

In the context of the present invention, the term “winding length” is to be understood as meaning the dimension of the winding as indicated by “length” in FIG. 1A, whereas the term “winding width” is to be understood as meaning the dimension of the winding as indicated by “width” in the same FIG. 1A. Furthermore, in the context of the present invention, the term “core cross section” is to be understood as the surface which normal is aligned with the longitudinal axis of a given portion of the core where said portion is considered. For example, the cross section of the central leg of an E core is the surface defined by a section of said central leg portion in a plan perpendicular to its longitudinal axis. A more complete understanding of the present invention may be had by reference to the following detailed description of particular embodiments when taken in conjunction with the accompanying drawings, wherein:

The FIG. A series illustrates the winding's geometric differences in a comparison between the technology used in the prior art vs. that used in the present invention.

FIG. A1 illustrates a Prior Art planar transformer, implemented with an off-the-shelf core EPCOS ELP64/ELP64. The winding turn is positioned around the central arm of the core. The core volume for this example is 41,500 mm³. The average length of the winding according to this prior art example is established as the average between the internal and external edges of the flat copper foil of which the winding is made, resulting in a winding length of 8″.

FIG. A2 illustrates a transformer according to the present invention, implemented with an off-the-shelf core EPCOS ETD 59. The winding turn is positioned around the central arm of the core. The winding with the surface of the foil parallel to the surface of the core reduces the winding length by more than 50% (to 3.2″) for the same number of winding turns, even though the surrounded core volume is slightly larger (51,200 mm³).

The FIG. 1. series illustrate the winding geometry used to minimize the effective winding length for a one turn winding geometry according to the present invention.

FIG. 1a is a 2D geometrical representation for a one turn winding, unwound.

FIG. 1b is a 2D geometrical representation for a one turn winding, wound.

FIG. 1c is a 3D geometrical representation for a one turn winding, wound.

FIG. 1d is a 2D representation of a transformer assembled with said one turn winding.

FIG. 1e is a 3D view of a transformer assembled with said one turn winding.

FIG. 1f is a 3D view of transformer assembled with a multilayer turn winding.

FIG. 1g is a Cross-sectional view along the longitudinal axis of a multilayer winding turn.

FIG. 1h is a 3D view of a primary winding with Litz wire, designed for placement over a secondary with no central tap.

The FIG. 2. series illustrate the implementation of the present invention in a two-turn winding geometry.

FIG. 2a is a 2D geometrical representation for a two turns winding, unwound.

FIG. 2b is a 2D geometrical representation for a two turns winding, wound.

FIG. 2c is a 3D geometrical representation for a two turns winding, wound.

FIG. 2d is a 2D representation of a transformer assembled with said two turns winding.

FIG. 2e is a 3D view of transformer assembled with said two turns winding.

The FIG. 3. series illustrate the implementation of the present invention in a one-turn winding geometry with a central tap.

FIG. 3a is a 2D geometrical representation for a one turn winding, unwound, with central tap.

FIG. 3b is a 2D geometrical representation for a one turn winding with central tap, wound.

FIG. 3c is a 3D geometrical representation for a one turn winding with central tap, wound.

FIG. 3d is a 2D representation of a transformer assembled with said one turn winding with a central tap.

FIG. 3e is a 3D view of transformer assembled with said one turn winding with a central tap.

FIG. 3f is a 3D view of a half primary winding made with Litz wire, designed for placement over a secondary winding provided with a central tap.

The FIG. 4. series illustrate the implementation of the present invention in a multiple turn winding geometry.

FIG. 4a is a 2D geometrical representation for four turns, unwound.

FIG. 4b is a 2D geometrical representation for four turns, wound.

FIG. 4c is a 3D geometrical representation for four turns, wound.

FIG. 4d is a 2D representation of a transformer assembled with said four turns winding.

FIG. 4e is a 3D view of transformer assembled with said four turns winding.

The FIG. 5. series illustrate the implementation of the present invention in a two-turns winding geometry that uses a central tap.

FIG. 5a is a 2D geometrical representation for a two turns winding with central tap.

FIG. 5b is a 2D geometrical representation for a two turns winding with a central tap, wound.

FIG. 5c is a 3D geometrical representation for a two turns winding with a central tap.

FIG. 5d is a 2D representation of a transformer assembled with said two turns winding with a central tap.

FIG. 5e is a 3D view of a transformer assembled with said two turns winding with a central tap.

The FIG. 6. series illustrate examples of a one-turn winding coil former.

FIG. 6a shows an example of a secondary winding coil former.

FIG. 6b Illustrates an example of a primary winding coil former that uses Litz wire.

FIG. 7. illustrates an example of a two-turn secondary winding coil former.

FIG. 8. illustrates an example of a four-turn secondary winding coil former.

FIG. 9. illustrates examples of a thermally conductive U-shaped top and a thermally conductive base plate connected via a compressible conductive pad featuring holes for facilitating its attachment to an external heat sink.

FIG. 10. Illustrates section through high turn ratio transformer that has a two-turn secondary winding with a central tap.

### DETAILED DESCRIPTION OF THE INVENTION

To minimize copper power losses, with respect to those of prior art and those of available planar transformers, the invention uses ferrite cores and an optimal winding construction and geometry. Given that the maximum power transferred from the primary to the secondary of a transformer is proportional to its core volume, the proposed invention reduces power losses by reducing the length of the secondary windings. Implicitly, the copper consumption and the costs are reduced accordingly. FIG. A1 illustrates an implementation of prior art technology. As an example, but not limited to, an EPCOS ELP64/ELP64 core is used (for details, the reader is referred to EPCOS, “Ferrites and accessories ELP64/ELP64,” Datasheet, September 2006). This particular core's volume is 41,500 mm³ and the resulting length of the winding or turn is approximately 175 mm, or 7″. FIG. A2 illustrates the concept of the proposed invention. For the purpose of example, but not limited to it, the invention is shown using an EPCOS ETD 59 core (for details, the reader is referred to EPCOS, “Ferrites and accessories, ETD 59,” Datasheet, September 2006). This particular core volume is 51,200 mm³. Using the same winding or turn cross-sectional area (e.g. so that the same maximum current density is transferred), the resulting winding turn length per the proposed invention is 80 mm, or 3.2″. This represents more than a 50% reduction in the secondary winding turn length, which, as a result, cuts power losses by more than one half. The concept of minimizing a winding turn length relies on the known mathematical fact that, among all geometrical two-dimensional (2-D) figures of fixed area, certain shapes or contours, such as circles or squares, have the lowest perimeter. In windings made of flat wire which orientation is perpendicular to the surface of the core, such as the exemplary case illustrated on FIG. A1, the length of the flat wire winding is calculated as the average between the length of the external edge—the one furthest away from the core's surface—and the length of the internal edge—the one closest to the core's surface. As a result, for typical cores, such as those described above, the winding turn length is reduced by at least or about 50% when the geometry of the winding replicates any of such minimal-length 2-D contours. Consequently, the proposed invention has significant efficiency and cost benefits over technologies presented or used in prior art. The embodiments presented herein can be implemented using several of the commercially available ferromagnetic cores, preferably made of ferrite, such as, but not limited to: E Cores, P Cores, PM Cores, RM Cores, U Cores, I Cores or ETD Cores.

The embodiments of this invention shorten the winding length by approximately 50% with respect to solutions used by prior art. For a winding wire of the same cross-sectional area, a 50% reduction in winding length translates into a 50% decrease in power losses. For the sake of example, let us calculate and compare the power losses resulting from the winding made according to the prior art planar technology and the winding made according to the present invention:

$${R}_{turn} = ρ \cdot \frac{Length}{S} \qquad ( 1 )$$

Where, ρ is the winding wire's electrical resistance, Length is the winding length and S represents the winding wire's cross-sectional area. If,

$${Length}_{invention} = \frac{{Length}_{planar}}{2} \qquad ( 2 )$$

Then:

$${R}_{invention} = \frac{{R}_{planar}}{2} \qquad ( 3 )$$

The copper power losses for the prior-art planar transformer winding can be computed as:

Pₚₗₐₙₐᵣ=Rₚₗₐₙₐᵣ·I_{copper}² (4)

Given that the invention herein reduces the resistance by 50%, the resulting power losses are also reduced by 50%:

$${P}_{invention} = {R}_{invention} \cdot {I}_{coppper}^{2} = \frac{{R}_{planar}}{2} \cdot {I}_{copper}^{2} = \frac{{P}_{planar }}{2} \qquad ( 5 )$$

In addition to a reduction in copper power losses, a shorter winding also results in material savings. As such, the present invention offers significant cost benefits over winding technologies used in the prior art. Additionally, given that the power losses along the winding, or copper losses, are half those of the prior art winding technologies, the amount of heat generated by these losses is considerably smaller. The resulting smaller heat dissipation requirements lend the invention suitable for many applications, including, but not limited to, applications that involve conduction cooling. Therefore the reliability of devices and systems using the present invention's winding is increased.

The following embodiments of the invention disclose optimal single- or multiple-turn winding geometries that can be used to minimize copper losses. These specific winding geometries are all based on the minimal-length 2-D contour concept described above.

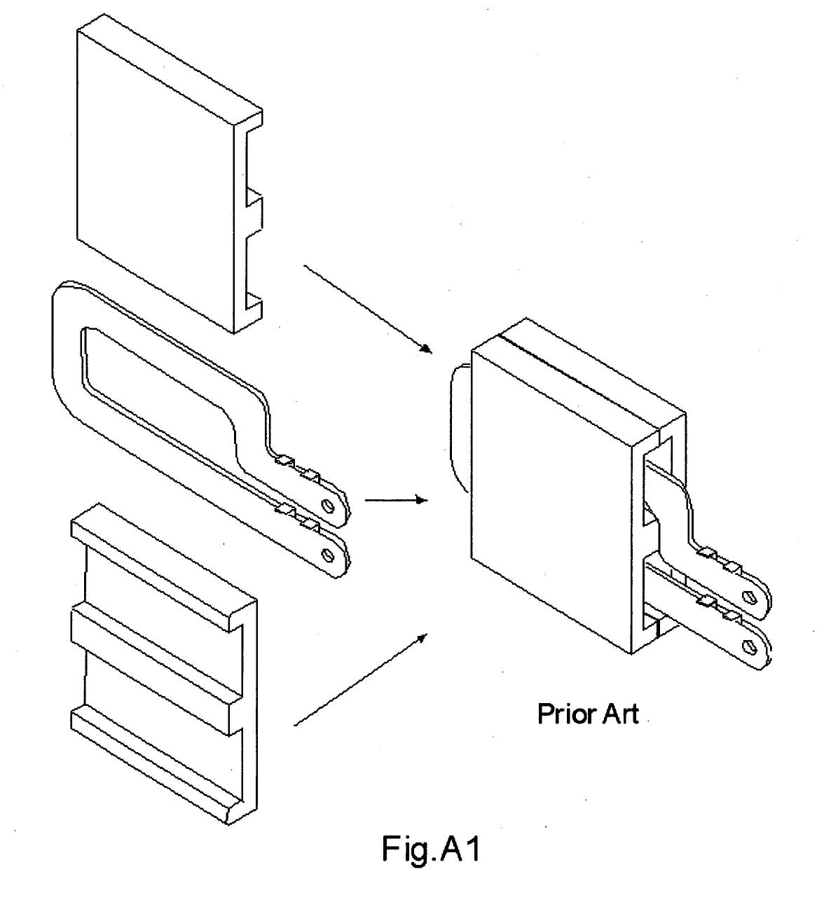

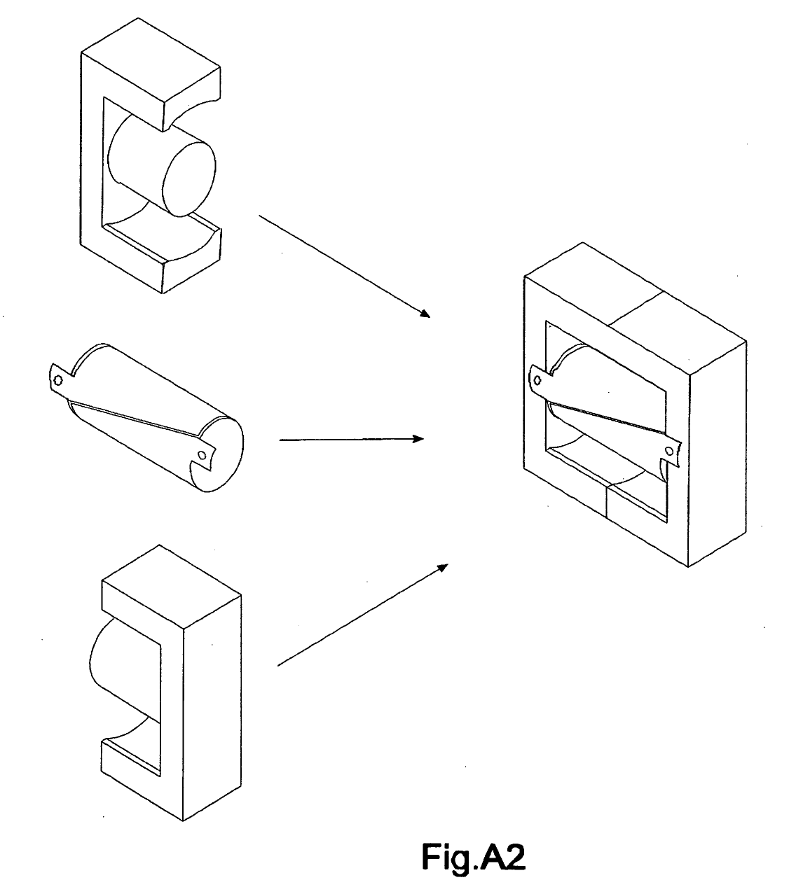

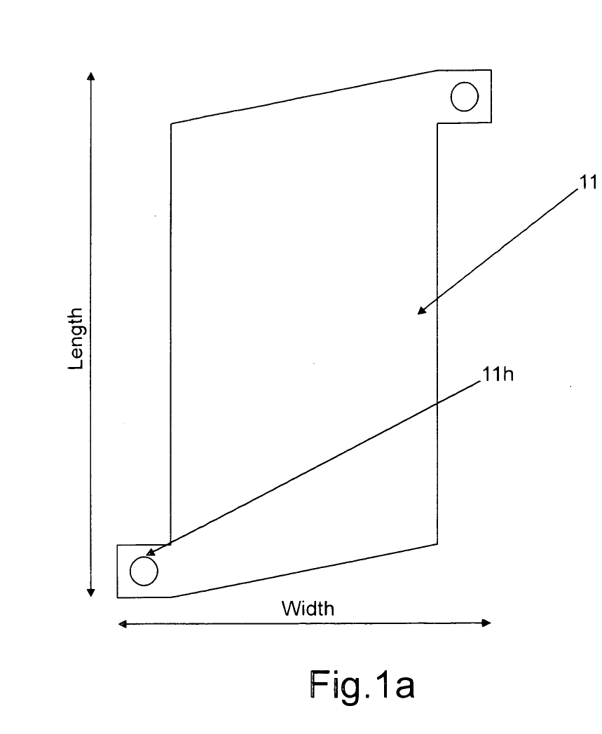

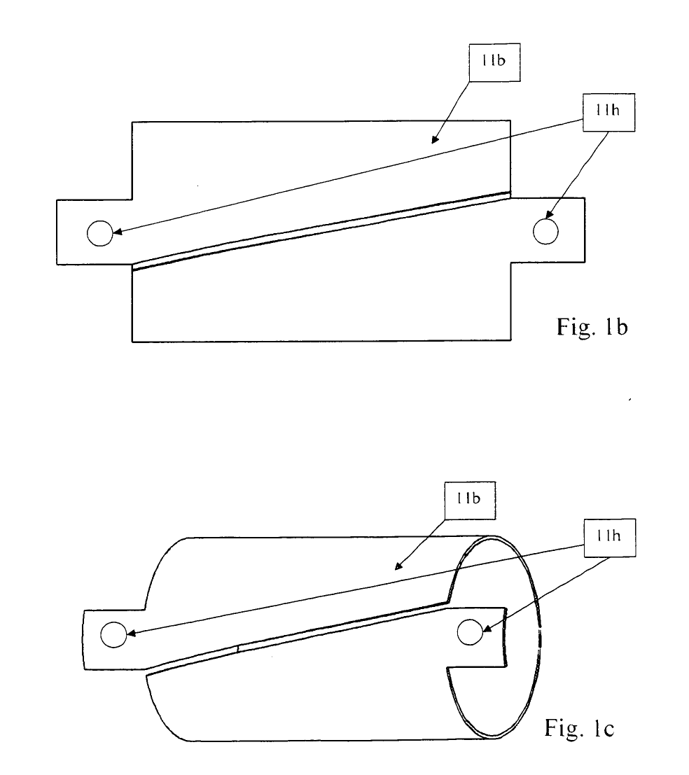

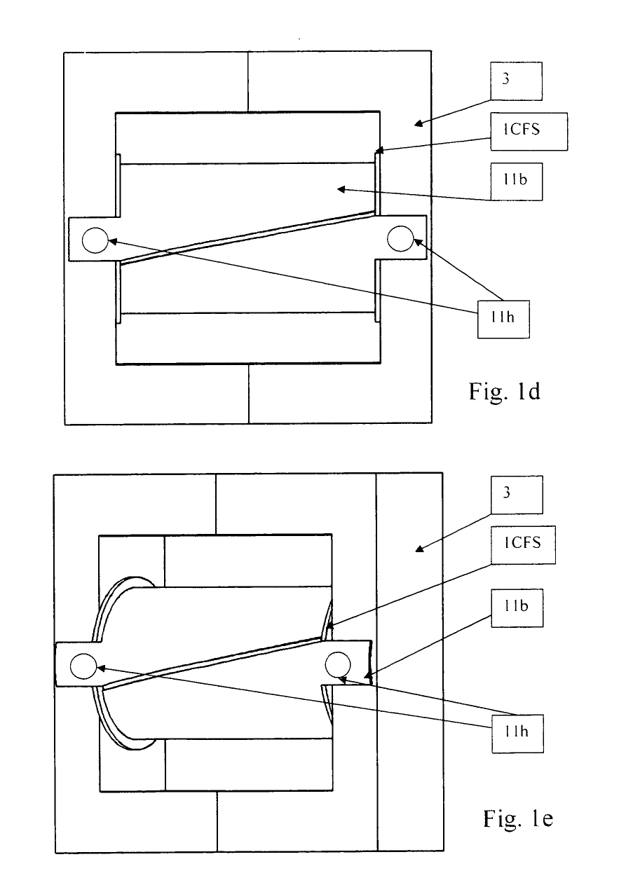

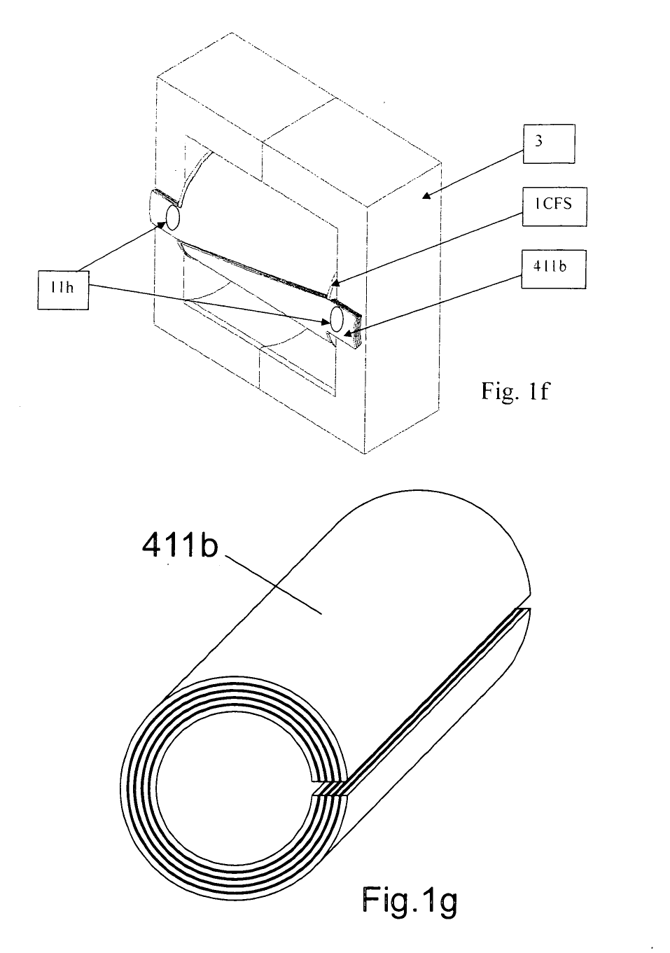

In a preferred embodiment, element 11 in FIG. 1a represents a planar view of a flat conductive material, in its unwound configuration, before it is rolled into a secondary winding. The holes 11h may be welded using bronze soldering nuts of characteristics according to the maximum current specified for the application, forming electrical terminals. These terminals formed from the holes 11h typically connect to a rectifying diode, synchronous rectifiers or other rectifying blocks, such as those used in switching power supplies. In addition to the magnitude of the current, factors such as switching power supply frequency and specified output power may be factors involved in the design of winding turn 11 and connecting holes 11h. FIG. 1b shows the same piece of flat conductive material 11 wound in the shape of a one turn winding. FIG. 1c illustrates a 3-D view of one turn winding 11. FIG. 1d represents one turn winding 11 assembled on a one turn winding coil former 1CFS, with the coil former positioned around the central arm of a ferrite core 3. FIG. 1e is a 3-D rendering of the same arrangement illustrated in FIG. 1d. As shown in FIG. 1f, an alternative embodiment of this same arrangement may use a winding of turn where a single sheet of flat conductive material is replaced by a multi-layered sheet, conforming axially concentric layers. The advantage of this arrangement is that the use of the copper section is optimized while eddy currents are minimized, preventing heat buildup. FIG. 1g shows a cross-sectional view taken along the longitudinal axis of a multilayer winding turn 411b wound over the ferrite core 3 illustrated in FIG. 1f. The layers could be for instance stamped foils. To avoid Eddy currents, there is electric insulation between adjacent layers being Kapton® tape an example of suitable insulator. FIG. 1h shows an example of primary winding that can be used in practicing the invention. Preferably, but not limited to, as shown in FIG. 1h, the primary winding could use Litz wire 1PLW to reduce AC power losses. The primary winding is wound over a winding coil former 1CFP. The winding coil former 1CFP ensures compliance with the requirements of safety standards, such as, but not limited to, creepage and clearance distances. The secondary winding coil 1CFS is mounted coaxially, within the primary winding. The winding coil formers 1CFS and 1CFP are dimensioned to provide a clearance space between them to minimize the corresponding leakage inductance and also to increase their degree of magnetic coupling. The soldering nuts that make up the previously described electric terminals are welded in after the primary winding is assembled over the secondary winding.

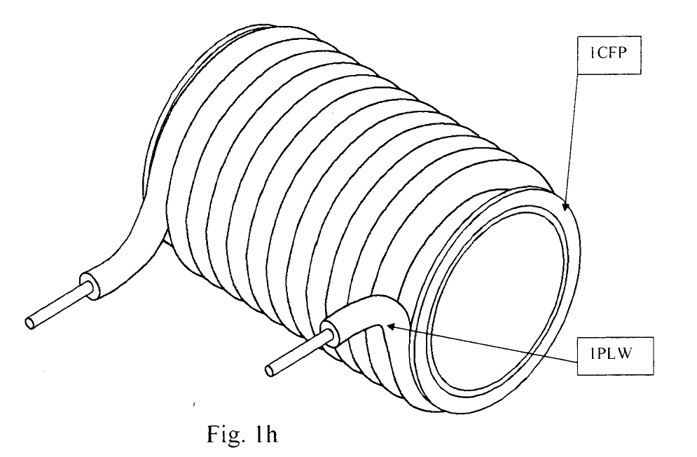

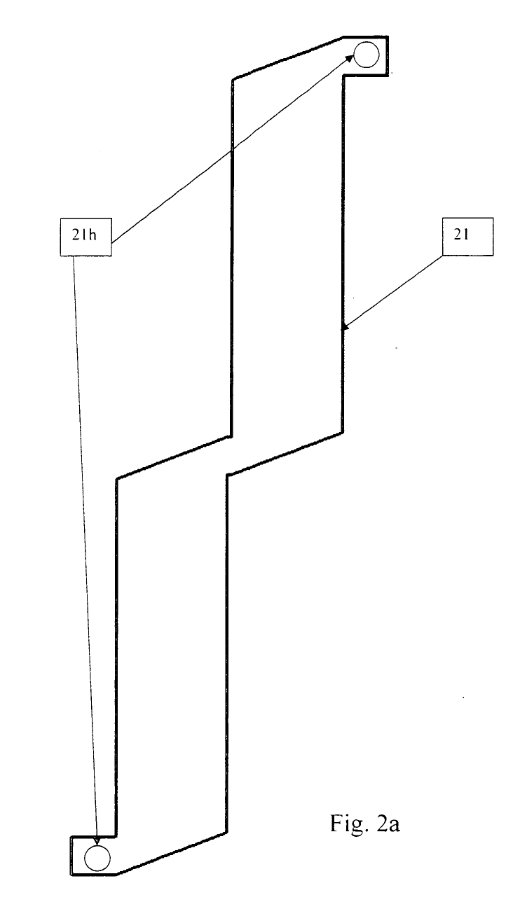

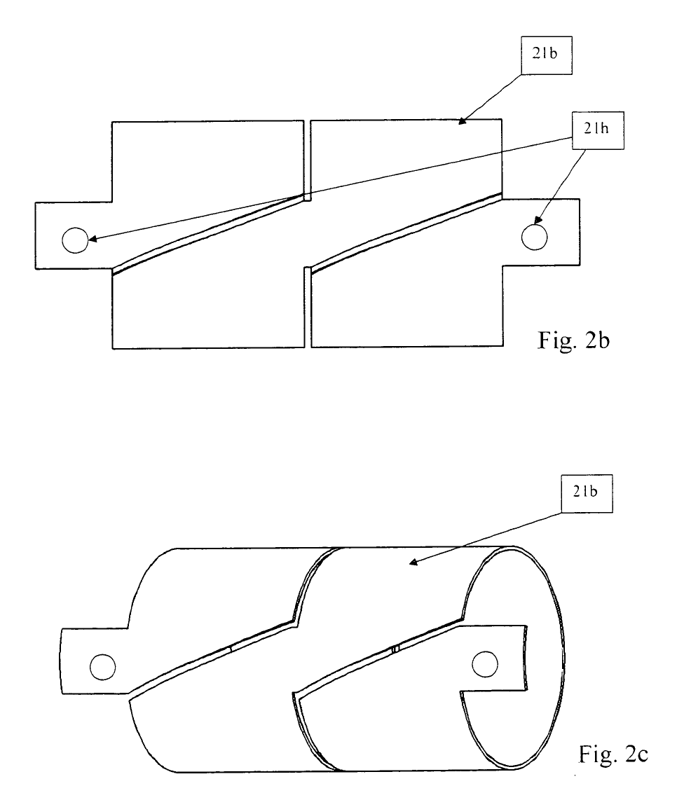

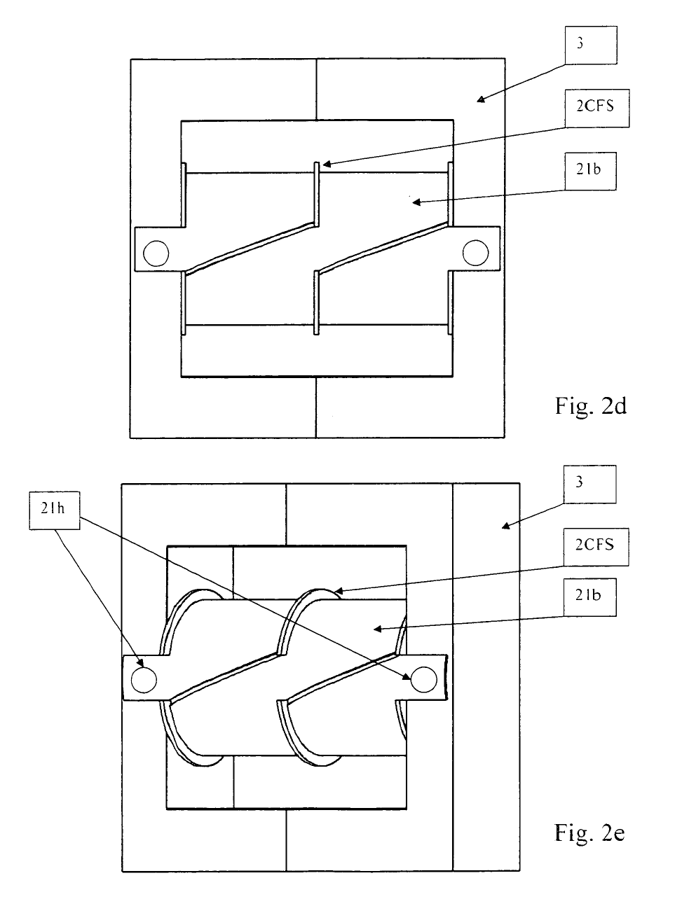

FIG. 2a shows a planar view of an alternative embodiment of the invention that uses a two-turn secondary winding 21, in an unwound configuration. Soldering nuts are welded into the mounting holes 21h. The width of one of the two turns is about half the width of the one-turn winding 11 shown in FIG. 1a. This two-turn winding 21 can be manufactured using a process equivalent to that used to manufacture the one-turn winding 11. For example, but not limited to, stamped foils, flexible PCB or winding over a winding coil former could be employed. FIG. 2b shows the winding 21 in its wound configuration. FIG. 2c is a 3-D rendering of the same winding. FIG. 2d shows such a winding, 21b, assembled over a two-turn secondary winding coil former 2CFS and positioned over the central arm of a ferrite core 3. FIG. 2e is a 3-D rendering of the same winding. Without limitation, one invention embodiment uses a primary winding similar to that shown in FIG. 1h.

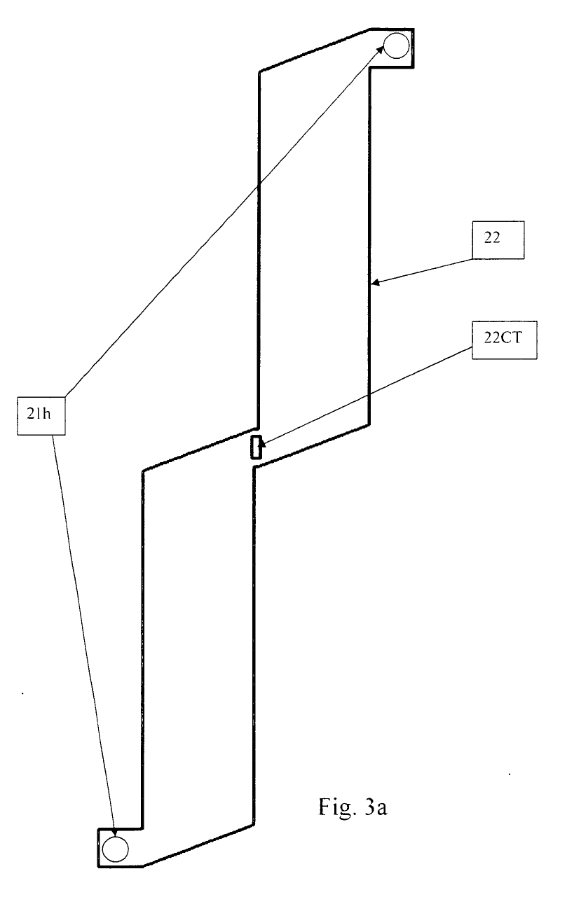

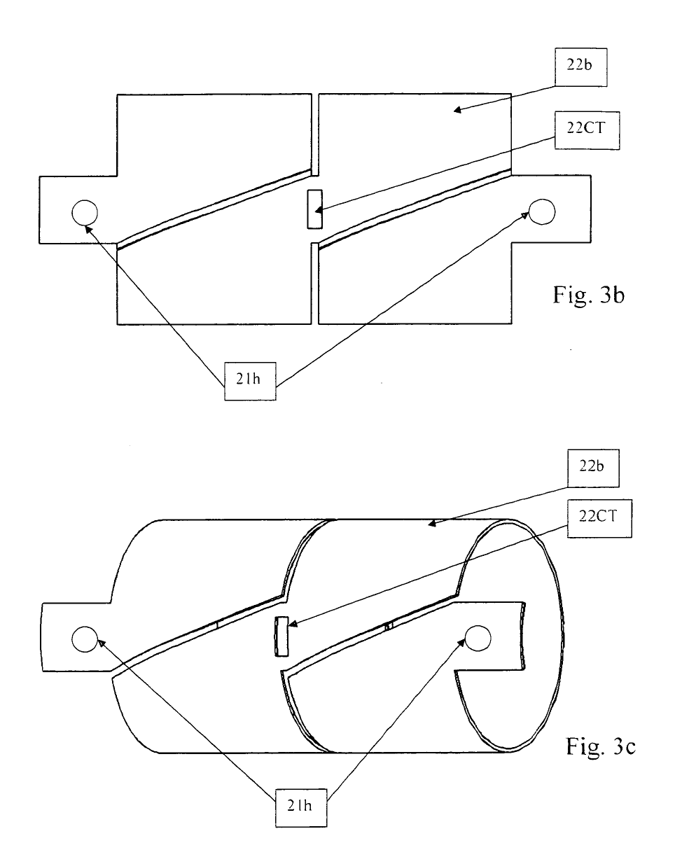

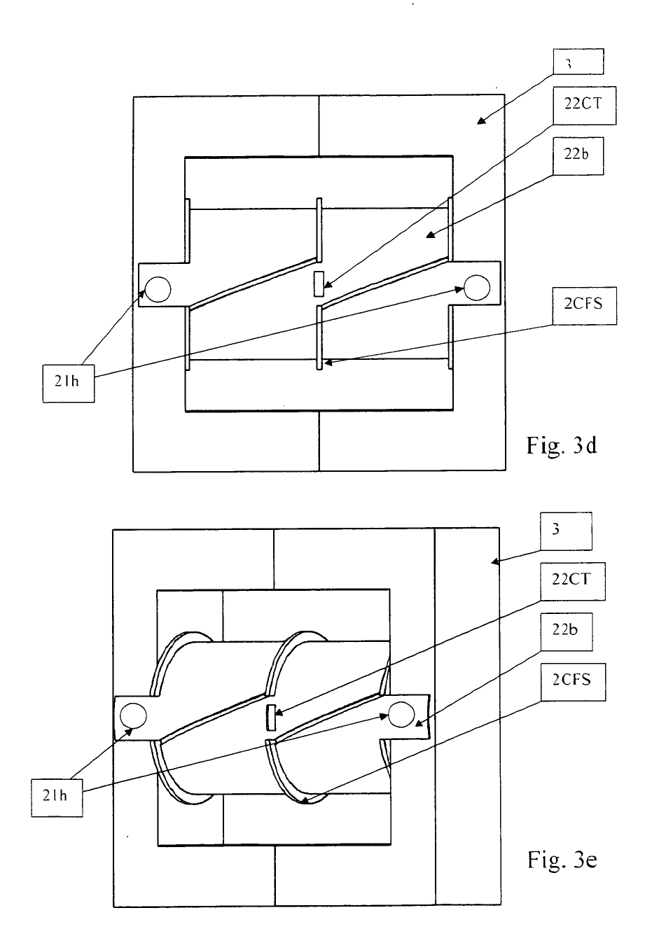

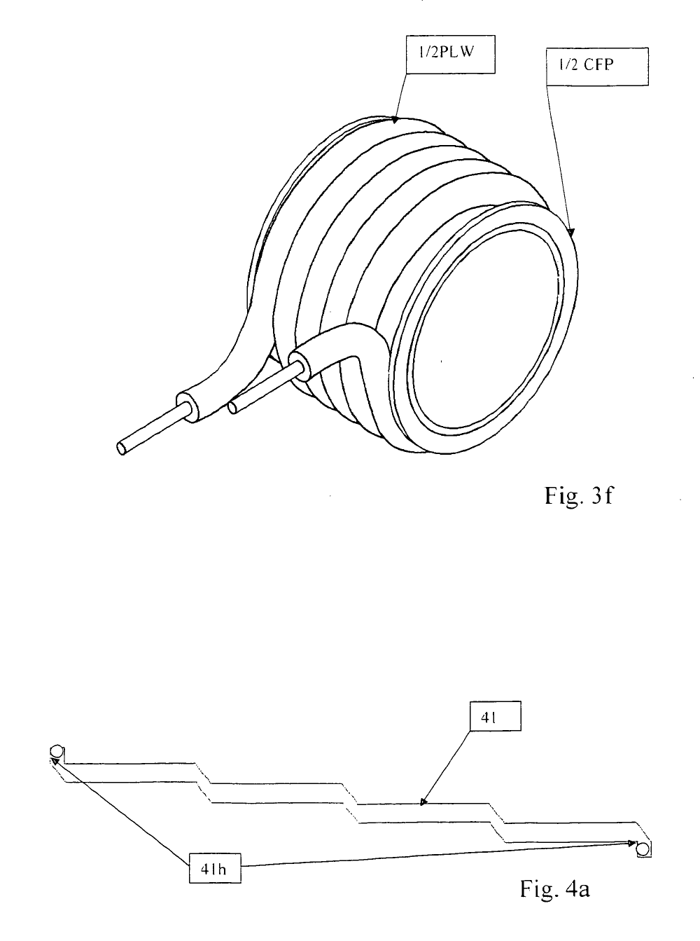

FIG. 3a illustrates an embodiment of the invention that uses a secondary winding featuring a central tap, 22CT. The central tap could be manufactured by stamping a rectangular hole in the general area indicated by 22CT in the Figure, at a point situated about half the length of the two-turn winding 22. An electrical connection could then be welded or soldered at this central tap 22CT. The central tap welding should be performed only after the winding turns are wound. Similarly, as in the previous embodiments discussed above, soldering nuts are welded at the holes 21h. The width of one of the two turns is about half the width of the one-turn winding 11, as shown in FIG. 1a. This two-turn winding can be manufactured using a process similar to the one used to manufacture the one-turn winding 11. For example, but not limited to, stamped foils, flexible PCB or winding over the winding coil former 2CFS could be employed. FIG. 3b shows the winding 22 in a wound configuration. FIG. 3c is a 3-D rendering of the same winding. FIG. 3d shows one such winding, 22b, assembled onto a winding coil former 2CFS and around the central arm of a ferrite core 3. FIG. 3e is a 3-D rendering of the same winding. FIG. 3f shows a primary half-winding ½PLW, which corresponds to the central-tap secondary. As before, it is preferred to use Litz wire to minimize AC power losses. The primary half-winding can be assembled over a winding coil former ½CFP. The winding coil former ½CFP ensures compliance with the requirements of safety standards, such as, but not limited to, creepage and clearance distances. The secondary winding coil 1CFS is mounted within the interior of the primary winding coil. The winding coil formers 1CFS and ½CFP are dimensioned to provide a clearance space between them that minimizes the corresponding leakage inductance and increases their degree of magnetic coupling. The two half-winding primaries ½CFP of FIG. 3f are coaxially introduced over the ends of the longitudinal axis of the secondary winding 22b, which is assembled over the former 2CFS. The soldering nuts are welded in after the primary winding is assembled over the secondary winding.

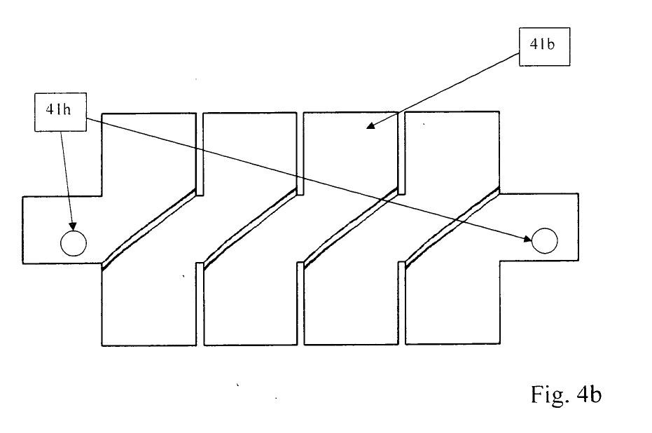

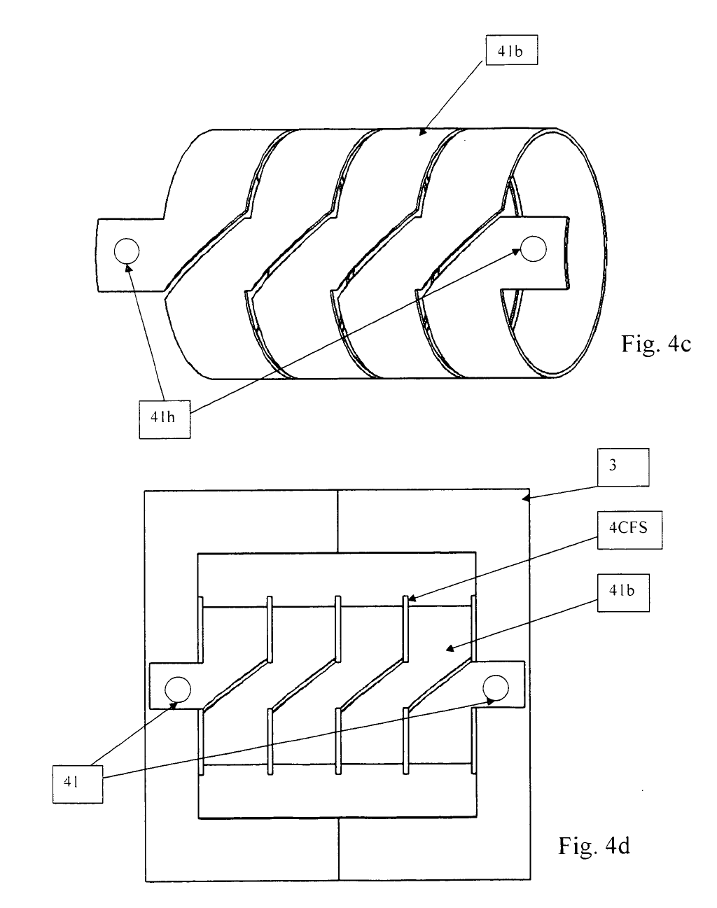

FIG. 4a shows a planar view of an alternative embodiment of the invention that uses a four-turn secondary winding 41 in an unwound configuration. Soldering nuts are welded into the mounting holes 41h. The width of one of the four turns is about one fourth of the width of the one-turn winding 11 shown in FIG. 1a. This four-turn winding can be manufactured using a process similar to the one used to manufacture the one-turn winding 11. For example, but not limited to, stamped foils, flexible PCB or winding over a winding coil former could be employed. FIG. 4b shows the winding 41 in a wound configuration. FIG. 4c is a 3-D rendering of the same winding. FIG. 4d shows one such winding, 41b, assembled over a four-turn secondary winding coil former 4CFS and around the central arm of a ferrite core 3. FIG. 4e is a 3-D rendering of the same winding. Without limitation, one invention embodiment uses a primary winding similar to that shown in FIG. 1h.

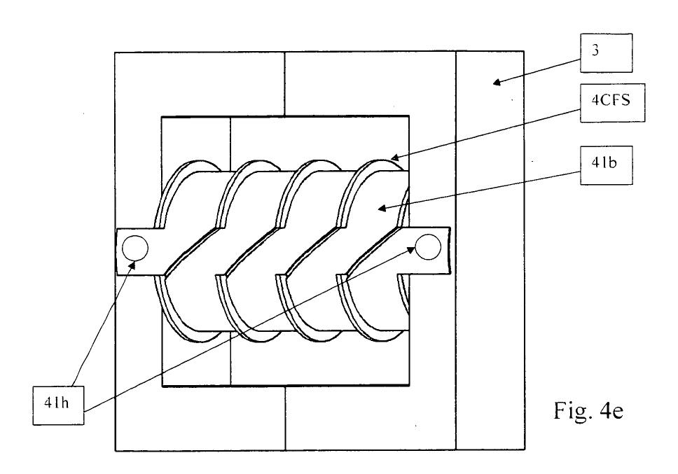

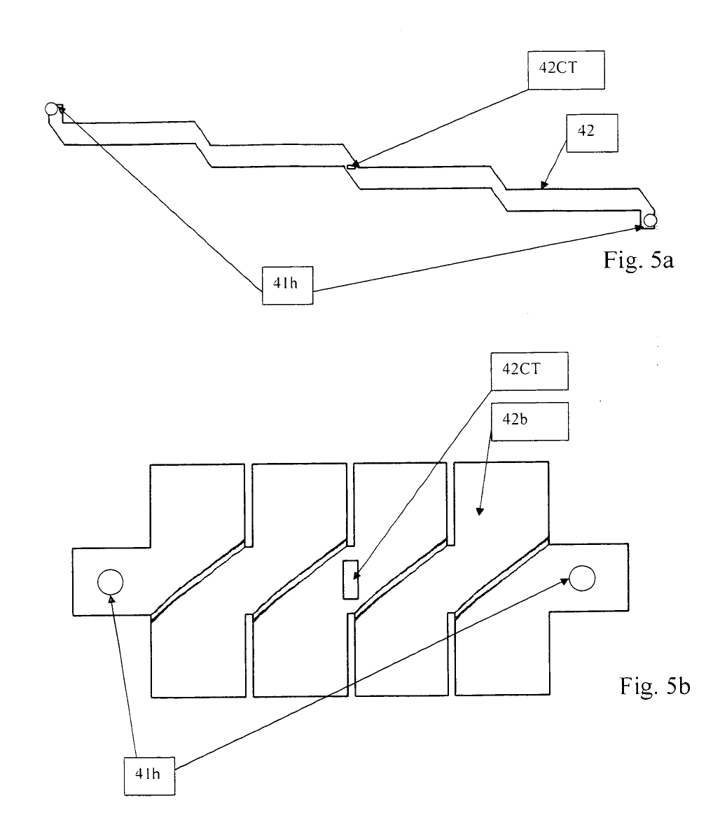

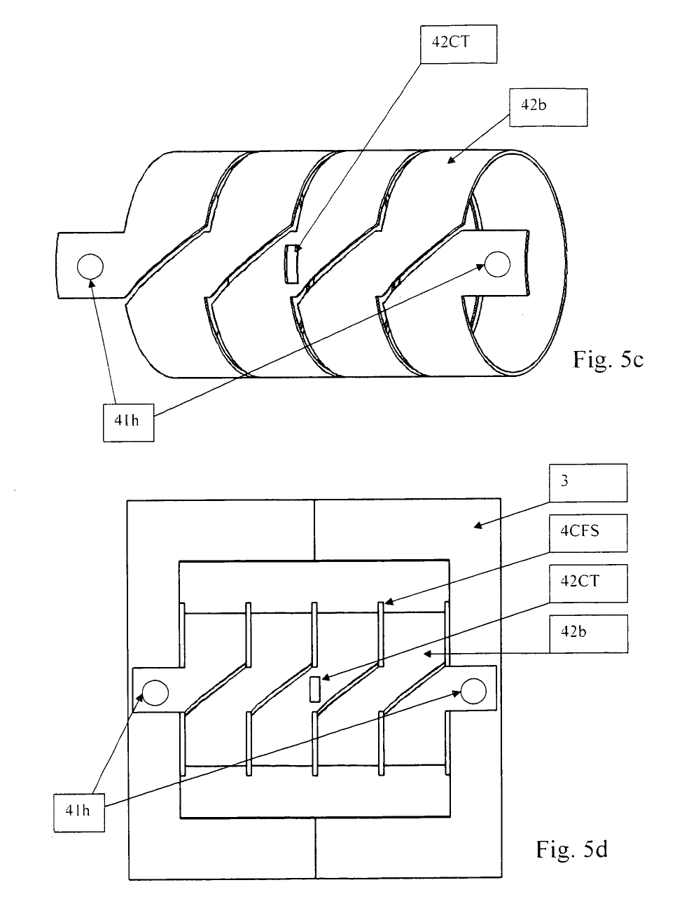

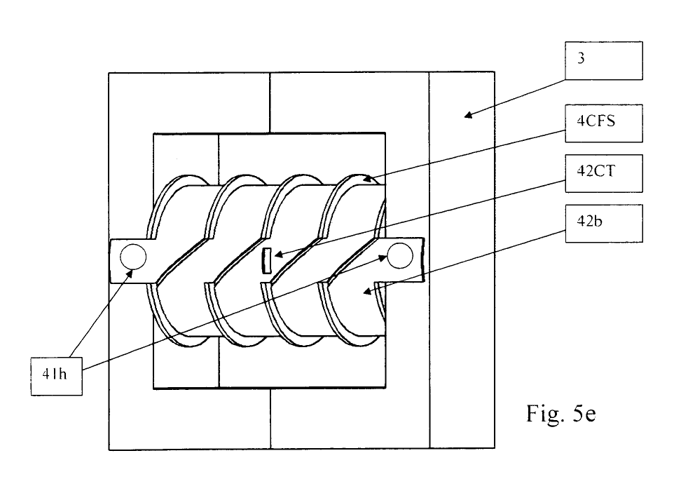

FIG. 5a illustrates an embodiment of the invention that uses a secondary winding with four turns and features a central tap, 42CT. The central tap could be manufactured by stamping a rectangular hole, 42CT, at a point situated about half the length of the four-turn winding 42. An electrical connection could then be welded or soldered at this central tap 42CT. The central tap welding should be performed only after the turns are wound. Similarly as in the previous embodiments discussed above, soldering nuts are welded at holes 41h. The width of one of the four winding turns is about one fourth the width of the one-turn winding 11, shown in FIG. 1a. This four-turn winding can be manufactured using a process similar to the one used to manufacture the one-turn winding 11. For example, but not limited to, stamped foils, flexible PCB or winding over a winding coil former 2CFS could be employed. FIG. 5b shows the winding 42 in a wound configuration. FIG. 5c is a 3-D rendering of the same winding. FIG. 5d shows one such winding, 42b, assembled onto a winding coil former 4CFS and around the central arm of a ferrite core 3. FIG. 5e is a 3-D rendering of the same winding. Without limitation, in one embodiment, the primary winding associated with the four-turn central-tap secondary winding 42 could be similar to that described for FIG. 3f.

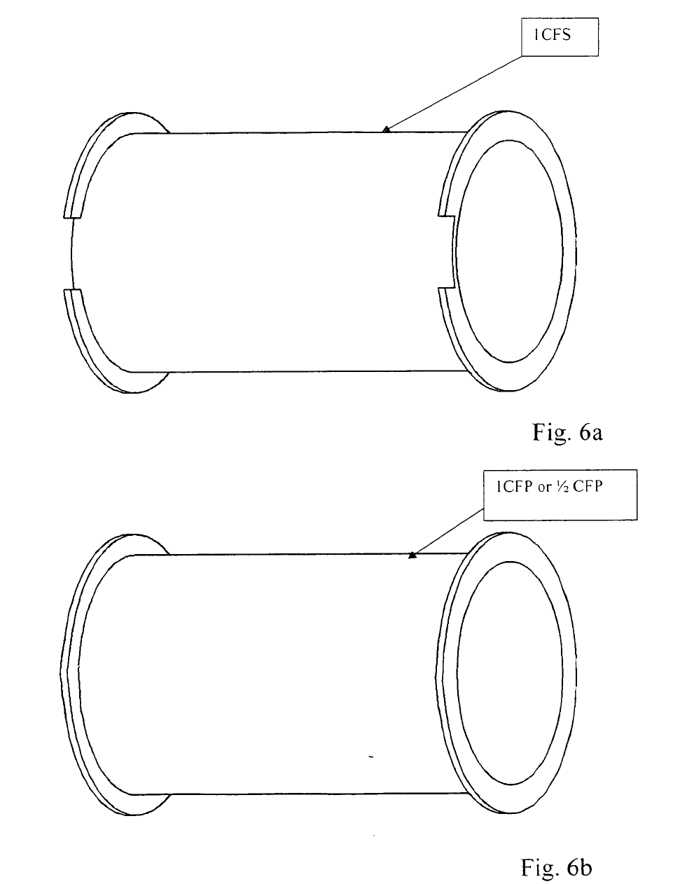

FIG. 6a shows winding coil former 1CFS, which is used for secondary windings, as described above. FIG. 6b, shows a winding coil former 1CFP, used for primary windings made with Litz wire, as described above. The dimensions and the materials of the winding coil formers are chosen to meet safety standards and to have a clearance space between them to minimize the corresponding leakage inductance and to increase their coupling.

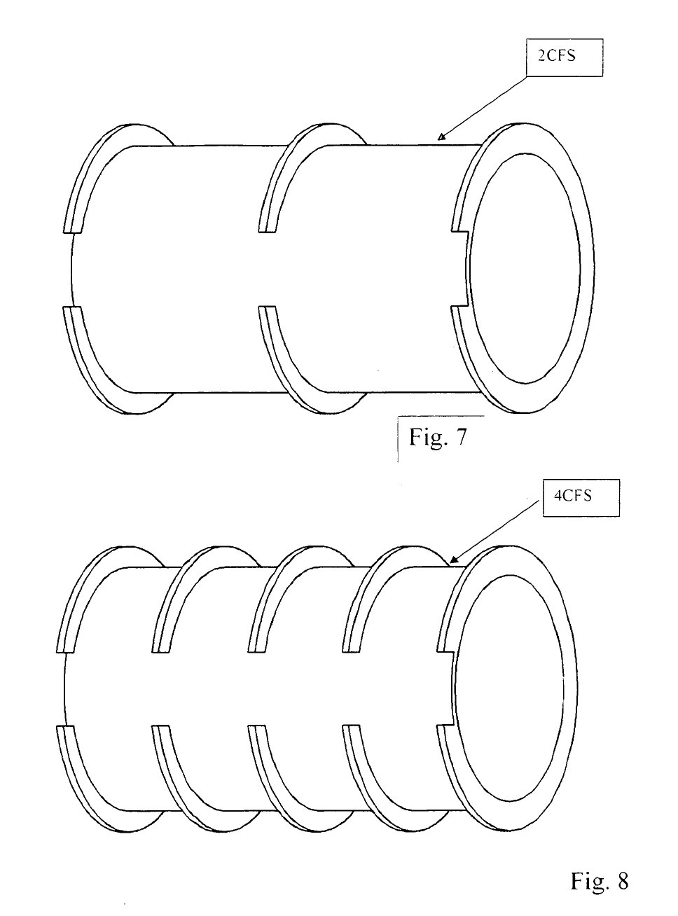

FIG. 7 shows a winding coil former 2CFS for a secondary winding with two turns, with or without a central tap.

FIG. 8 shows a winding coil former 4CFS for a secondary winding with four turns, with or without a central tap.

FIG. 9 shows a method to reduce temperature rises in the transformer. Without limitation, this method may be employed in applications that involve conduction cooling. The core 3 is placed in contact with a thermally conductive U-shaped top 9u and a thermally conductive base plate via a compressible conductive pad 9i featuring holes 9h for facilitating its attachment to an external heat-sink.

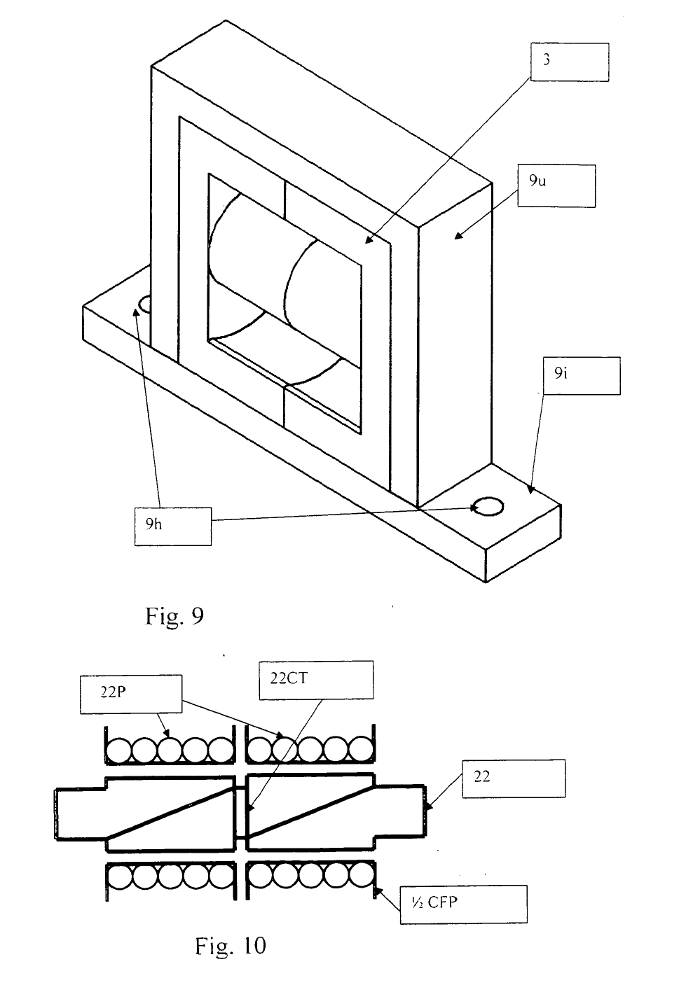

FIG. 10 illustrates a longitudinal cross-section through a transformer that has a high turn ratio. The secondary winding employs a two-turn winding 22 with a central tap 22CT, equivalent to the one described for FIG. 3a. The primary winding, made of Litz wire to reduce AC power losses, combines two winding coil formers ½CFP that are electrically connected in series. For applications that use a low turn ratio (e.g. less than 4:1), the primary and secondary windings follow the winding geometries described above. The winding coil formers are designed such that the primary goes over the secondary. Without limitation, common applications that could benefit from the invention described above are: power supplies for automotive systems, for telecommunication and intermediary bus converters.

It should be appreciated that those skilled in the art could provide modifications to the matter disclosed above without significantly departing from the spirit of the proposed invention. Those skilled in the art will understand that certain materials or dimensions could be modified without departing from the spirit and scope of the invention as indicated in the following set of claims.

I claim:

1. A method to minimize copper losses in magnetics of at least one winding turn, the method comprising the minimization of the length of the said at least one turn by winding a continuous copper foil of a specific geometrical design at least one turn over a ferromagnetic core with the surface of the foil parallel to the surface of the core, so as to achieve a winding turn-length quasi-equal to the length of the core cross-section perimeter, effectively surrounding the entire cross-sectional area of the ferromagnetic core.

2. The method of claim 1, wherein the ferromagnetic core is a ferrite.

3. The method of claim 1, wherein said at least one winding turn is made of copper foil.

4. The method of claim 1, wherein said at least one winding turn is made of flexible PCB.

5. The method of claim 1, wherein said at least one winding turn features a central tap.

6. The method of claim 1, wherein said at least one winding turn is made of multiple layers.

7. A magnetics winding comprising at least one winding turn that, for a given magnetics core volume, features a minimized length obtained by winding a continuous copper foil of a specific geometrical design at least one turn around a ferromagnetic core to achieve a winding turn-length quasi-equal to the length of the core cross-section perimeter, thus effectively surrounding the entire cross-sectional area of the ferromagnetic core.

8. The winding of claim 7, wherein the ferromagnetic core is a ferrite.

9. The winding of claim 7, wherein said at least one winding turn is made of copper foil.

10. The winding of claim 7, wherein said at least one winding turn is made of flexible PCB.

11. The winding of claim 7, wherein said at least one winding turn features a central tap.

12. The winding of claim 7, wherein said at least one winding turn is made of multiple layers.

13. A transformer comprising a secondary winding with at least one winding turn that features reduced copper losses by minimizing the said at least one turn length by winding a continuous copper foil of a specific geometrical design at least one turn over a ferromagnetic core with the surface of the foil parallel to the surface of the core, so as to achieve a winding turn-length quasi-equal to the length of the core cross-section perimeter, thus effectively surrounding the entire cross-sectional area of the ferromagnetic core.

14. The transformer of claim 13, wherein a low turn ratio is used.

15. The transformer of claim 13, wherein a high turn ratio is used.

16. The transformer of claim 13, wherein proper creepage and clearance are provided by using secondary winding coil formers.

17. The transformer of claim 13, wherein proper creepage and clearance are provided by using primary winding coil formers.

18. The transformer of claim 17, wherein the primary winding coil former supports Litz wire windings.

19. The transformer of claim 13, wherein said transformer core is placed in contact with a thermally conductive U-shaped top and a thermally conductive base plate via a compressible conductive pad featuring holes for facilitating its attachment to an external heat-sink.
